(19) United States
(12) Patent Application Publication
(10) Pub. No.: US 2013/0175289 A1
(43) Pub. Date: Jul. 11, 2013

(54) LABEL DISPENSER UNIT

(71) Applicant: Todd Sternberg, Dallas, TX (US)

(72) Inventor: Todd Sternberg, Dallas, TX (US)

(21) Appl. No.: 13/345,172

(22) Filed: Jan. 6, 2012

(51) Int. Cl. B65C 9/18; B65C 11/00; B65H 75/28; B65C 9/42

(52) U.S. Cl. 221/70; 242/579; 242/587.2

(57) ABSTRACT

A label dispenser unit comprising a dispensing reel for supporting a roll of labels attached to a backing strip. The dispenser unit also includes a label releasing station for separating the label from the backing strip and a central take-up hub for receiving the backing strip thereon. The take up hub is formed of a hub portion and a plurality of radially extending spokes extending from the central hub portion. The backing strip extends from the roll of labels around the label releasing station such that an end of the backing strip is secured to the take-up hub between at least two radially extending spokes.

### BACKGROUND

Labels with pressure-sensitive adhesive thereon are oftentimes attached to a strip of coated paper (i.e., a backing strip) and stored on a roll. In order to easily remove the labels from the backing strip, automated and semi-automated label dispensers and applicators have been devised. One common type of arrangement releases labels from a label roll by passing the backing strip over a bar or plate and turning or otherwise wrapping the backing strip in an abrupt turn beneath the bar or plate. This turn causes the leading edge portion of the label to separate from the backing strip since the labels are formed of a material that tends to resist the bending necessary to negotiate the turn. However, many existing systems require numerous parts and thus, become increasingly expensive to manufacture. Furthermore, other systems lack effective mechanisms for applying tension to the backing strip as it passes over the plate while separating the label from the backing strip.

### BRIEF DESCRIPTION OF THE DRAWINGS

FIG. 1 is a front perspective view of an improved label dispenser assembly;

FIG. 2 is a side view of the label dispenser assembly of FIG. 1;

FIG. 3 is a perspective view of an improved take-up hub illustrated in FIGS. 1 and 2;

FIG. 4 is a side view of the take-up hub illustrated in FIG. 3; and

FIGS. 5A and 5B illustrations of a guide element disposed on a guide rod contained in the label dispense assembly of FIG. 1.

### DETAILED DESCRIPTION

In the description which follows, like parts are marked throughout the specification and drawings with the same reference numerals, respectively. The drawings are not necessarily to scale and certain features may be shown exaggerated in scale or in somewhat schematic form in the interest of clarity and conciseness.

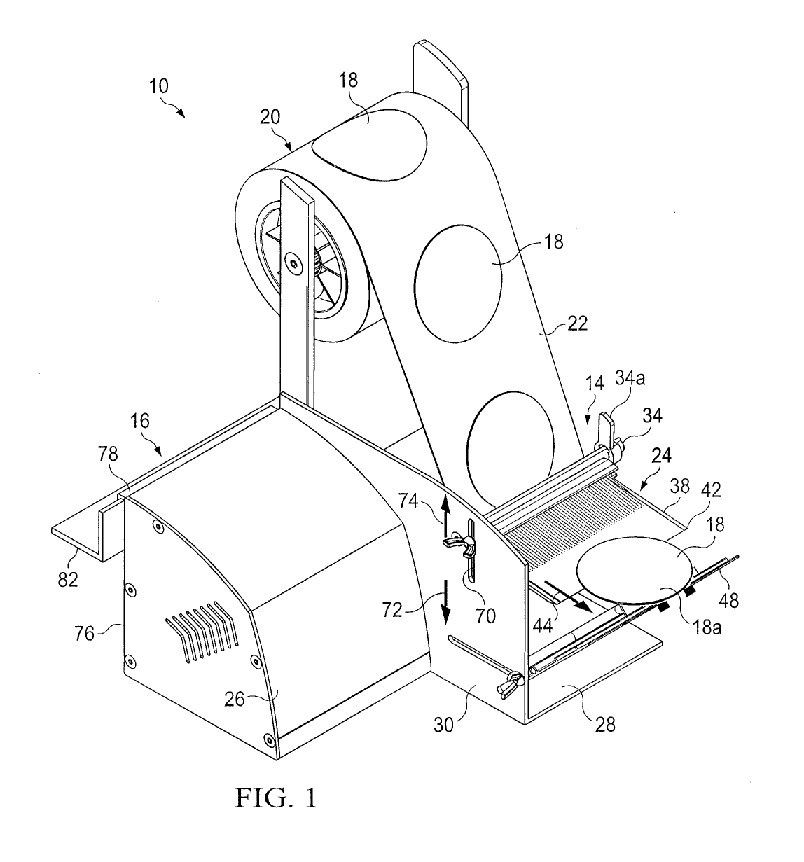

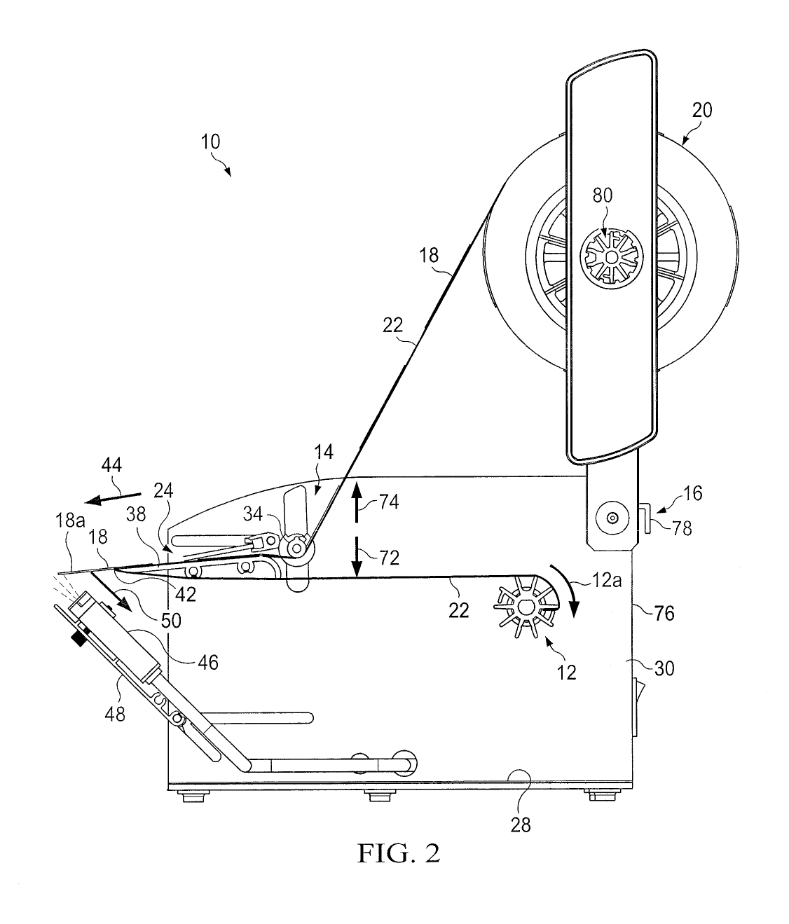

FIGS. 1 and 2 illustrate a label dispenser unit 10 in which an improved take-up hub 12, tensioning system 14 and mounting mechanism 16 are employed to advantage. In operation, label dispenser unit 10 dispenses adhesive labels 18 disposed on a label roll 20 by automatically peeling a leading edge portion 18a of label 18 from a backing strip 22 as the backing strip 22 is pulled through a label releasing station 24. After label 18 is removed from backing strip 22, backing strip 22 is pulled toward and rolled onto take-up hub 12, which is rotated by an electric motor (not illustrated) disposed within a motor housing 26 (FIG. 2).

As illustrated in FIGS. 1 and 2, dispenser unit 10 includes a horizontal support section 28 for supporting dispenser unit 10 on a support surface, and a generally upright or vertical support section 30 extending perpendicularly from horizontal section 28 for supporting various components of dispenser unit 10. For example, motor housing 26 is removably secured to vertical support section 30 and is sized to store the electric motor and other operational components used in the control and operation of dispenser unit 10.

Referring specifically to FIG. 2, backing strip 22 extends from roll 20 beneath a tensioning/guide rod 34 and through label releasing station 24. As backing strip 22 passes through label releasing station 24, backing strip 22 turns in the opposite direction toward and onto take-up hub 12, where the used portion of backing strip 22 (i.e., portions having label 18 removed therefrom) are rolled onto and stored thereon. In operation, as the motor is actuated, take-up hub 12 rotates in the direction of arrow 12a thereby providing a pulling force on backing strip 22 to pull backing strip 22 through label releasing station 24. As backing strip is pulled, leading portion 18a separates from backing strip 22. It should be understood, however, that the motor is operable in the reverse direction in order to rotate take-up hub 12 in the opposite direction of arrow 12a to provide a pulling force on backing strip 22.

In the embodiment illustrated in FIG. 2, label releasing station 24 comprises a plate 38 having a planar surface to enable backing strip 22 to slide therealong and bend or otherwise abruptly turn around an edge 42. As backing strip turns around edge 42, leading portion 18a separates from backing strip 22 since labels 18 are of a sufficient stiffness to resist the bending necessary to negotiate the abrupt turn around edge 42. After separation, leading edge portion 18a continues forward in the direction of arrow 44 until at least a portion of label 18 is detected by a sensor/detector 46 (best illustrated in FIG. 2). In the embodiment illustrated in FIGS. 1 and 2, sensor 46 comprises an optical sensor mounted on a support plate 48, the sensor 46 being operable to detect leading portion 18a as it travels through a beam path generated by sensor 46. After detection, a signal is generated to stop further rotation of take-up hub 12, and thus, movement of backing strip 22 until label 18 is removed so that it no longer blocks the beam path. Once removed, a signal is generated to enable the motor to rotate take-up hub 12 to pull the next adjacently positioned label through label releasing station 24 until another label 18 is positioned across the beam path generated by sensor 46. While FIGS. 1 and 2 illustrate an optical sensor, it should be understood that any type of sensor device, detector or other method can be used to detect leading edge portion 18a and thus stop rotation of take-up hub 12.

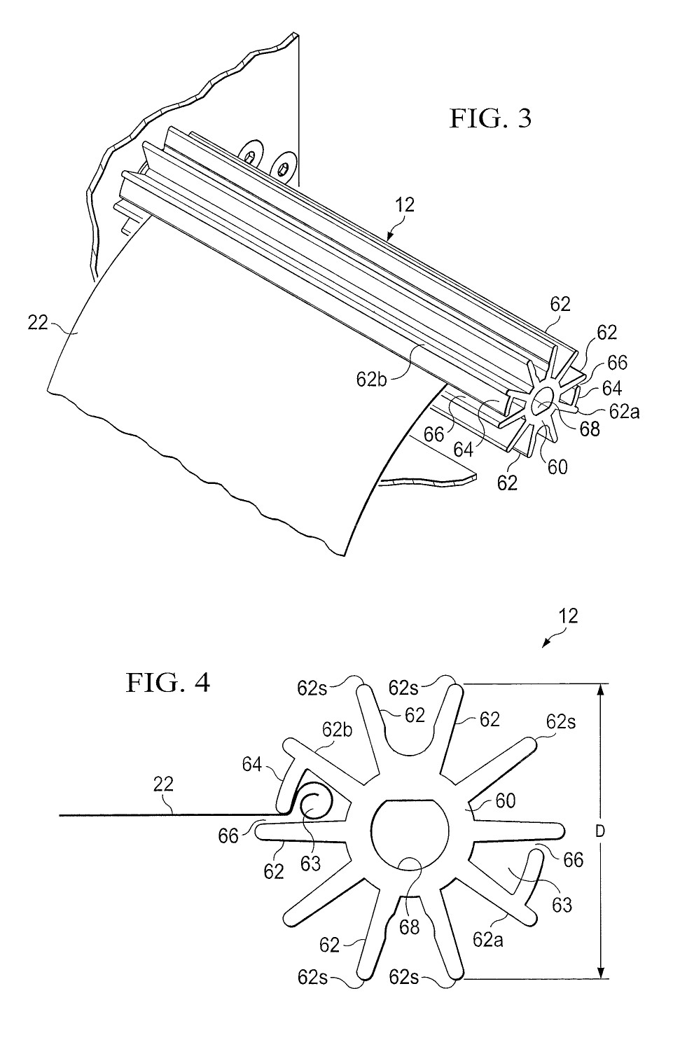

Referring now to FIGS. 3 and 4, take-up hub 12 is formed of a central hub portion 60 having spaced apart spokes 62 radially extending therefrom. At least one spoke 62 comprises a cantilevered portion 64 extending therefrom toward a second and adjacently positioned spoke member 62. According to the embodiment illustrated in FIGS. 3 and 4, the end of cantilevered portion 64 is spaced apart from spoke member 62 forming a gap 66 to facilitate access to a chamber 63, which is formed by two adjacently positioned spoke members 62 and cantilevered portion 64 extending therebetween. Chamber 63 and sized to receive an end of backing strip 22. In the embodiment illustrated in FIGS. 3 and 4, two spokes 62a and 62b contain cantilevered portions 64; however, it should be understood that a greater or fewer number of spokes 62 can comprise cantilevered portions 64. Embodiments of take-up hub 12 disclosed herein provide a quick and easy method of attaching the backing strip 22 to take-up hub 12 without the use of tools or requiring any additional components to secure backing strip 22 to take-up hub 12.

During initial setup, for example, label roll 20 is secured onto dispenser unit 10. Once secured, the exposed end of backing strip 22 is fed underneath guide rod 34 and pulled around plate 38 until the end is aligned with and otherwise inserted through gap 66 and into chamber 63. Take-up hub can then be rotated in the direction of arrow 12a (FIG. 2) so that backing strip 22 self-locks and wraps around take-up hub 12. Once backing strip 22 is locked onto take-up hub 12, rotation of take-up hub 12 generates the pulling force, as described above, to cause labels 18 to be separated from backing strip 12 when passing through label releasing station 24.

Preferably, each spoke 62 extends a length from central hub portion 60 such that the ends of each spoke 62 form a generally circular support surface 62s (FIG. 4) for supporting backing strip 22 at periodic intervals when backing strip 22 is wrapped around take-up hub 12 (FIG. 1). As seen in FIGS. 3 and 4, take-up hub 12 includes an opening 68 shaped for receiving a correspondingly shaped motor driven shaft (not illustrated) thereby preventing relative movement between take-up hub 12 and the motor shaft. In FIGS. 3 and 4, opening 68 is generally “D” shaped to correspond to a similarly shaped motor driven shaft; however, it should be understood that the shape of opening 68 can be any size or shape corresponding to correspond to a motor shaft. Accordingly, as the motor rotates take-up hub 12, the backing strip 22 is wound onto the take-up hub 12.

Preferably, take-up hub 12 is formed by an aluminum extrusion process; however, it should be understood that take-up hub 12 can be otherwise formed of any type of material using a variety of manufacturing methods. In addition, take-up hub 12 is configured to be optionally interchangeable to act as a dispensing reel 80 to enable roll 20 to be mounted on dispensing unit 10, as best illustrated in FIG. 2.

Referring back to FIGS. 1 and 2, guide rod 34 is adjustable to increase or decrease the tension applied to backing strip 22 as it wraps around plate 38. For example, if there is insufficient tension, label 18 may dispense at a lower dispensing angle and otherwise deflect downward in the direction of arrow 50 (FIG. 2), which may cause label 18 to contacting sensor 46 and/or otherwise avoiding detection by sensor 46 altogether. Accordingly, a slot 70 (FIG. 1) is formed on vertical support section 30 to enable guide rod 34 to be movable in the direction of arrows 72 and 74 to increase or decrease the tension on backing strip 22. For example, in the event increased tension of backing strip 22 is needed (i.e., in instances when label 18 deflects excessively downward in the direction of arrow 50), guide rod 34 is moved downward within slot 70 in the direction of arrow 72 to exert a downward force on backing strip 22 to reduce the amount of deflection of label 18. Likewise, in the event decreased tension is needed (i.e., to enable label 18 to be deflect in the direction of arrow 50), guide rod 34 is raised within slot 70 in the direction of arrow 74 thereby reducing the downward force on backing strip 22.

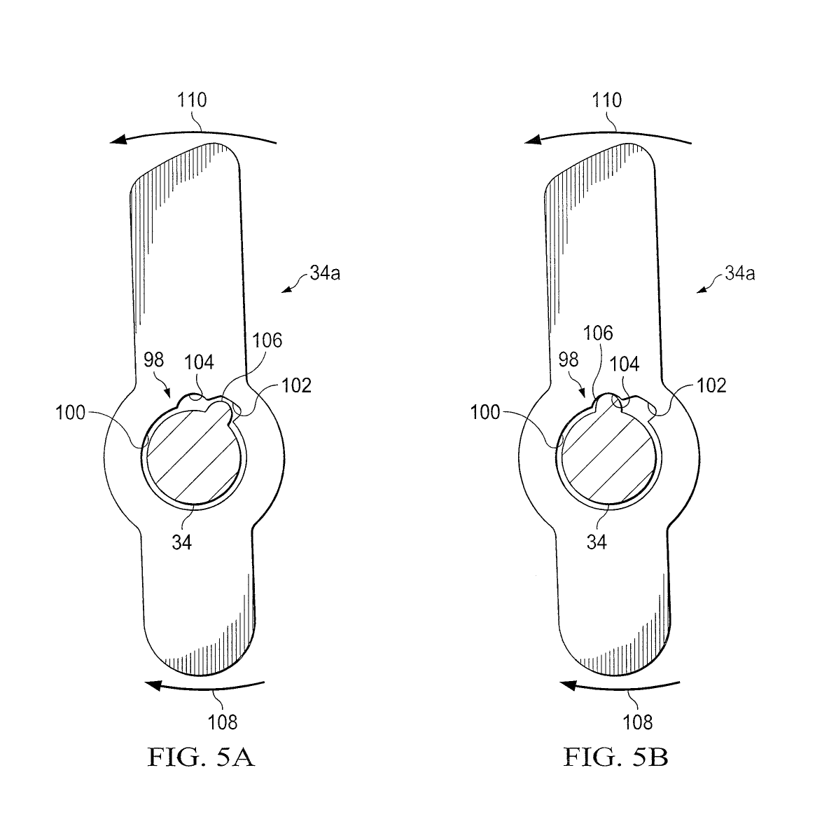

Referring now to FIGS. 1 and 5A-5B, guide element 34a is movably disposed on guide rod 34 so as to adjust for differing size widths of backing strip 22. For example, for backing strips 22 having smaller widths than the backing strip 22 illustrated in FIG. 1, guide element 34a can be repositioned on guide rod 34 closer to vertical support section 30. Likewise, for backing strips 22 having wider widths than the illustrated backing strip 22, guide element 34a can be repositioned on guide rod 34 at a position further way from vertical support section 30.

In the embodiment illustrated herein, a guide element 34a is frictionally locked onto guide rod 34 by a locking system 98 to prevent movement of guide element 34a relative to and along guide rod 34. Briefly, guide element 34a comprises a central opening 100 sized to correspondingly receive guide rod 34 therein. Central opening 100 comprises a first groove 102 and a second groove 104, the second groove 104 having a slightly shallower depth than the depth of groove 102. In the embodiments illustrated in FIGS. 5A and 5B, groove 102 is sized such that a protrusion 106, which extends from the outer surface of guide rod 34, fits therein with sufficient clearance from the inner surface of groove 102 to prevent frictional engagement between protrusion 106 and groove 102. Accordingly, when guide rod 34 is positioned such that protrusion 106 is disposed therein, guide element 34a is in an “unlocked” position to facilitate sliding movement along the length of guide rod 34. This enables guide element 34a to adjust to the width of differing sized backing strips 22. Once guide element 34a is properly positioned, guide element 34a is rotated in the direction of arrow 108 so that protrusion 106 is disposed within groove 104 (FIG. 5B) and in a “locked” position. As illustrated in FIGS. 5A and 5B, groove 104 is sized such that protrusion 106 frictionally engages the inner sidewall of groove 104, which acts to resist movement of guide element 34a relative to guide rod 34 to lock the position of guide element 34a. When it is desired to move or otherwise adjust the position of guide element 34a on guide rod 34, guide element 34a is rotated in the direction of arrow 110 such that protrusion 106 is repositioned back into groove 102, which allows for sliding movement of guide element 34a relative to guide rod 34.

According to some embodiments, mounting mechanism 16 is disposed on rear wall 76 of motor housing 26. In the embodiment illustrated in FIGS. 1 and 2, mounting system 16 includes, for example, an “L” shaped bracket 78 for mounting to a wall, rack and/or support 82 as best seen in FIG. 1.

Although embodiments of label dispenser unit 10 have been described in detail, those skilled in the art will also recognize that various substitutions and modifications may be made without departing from the scope and spirit of the appended claims.

What is claimed is:

1. A label dispenser unit, comprising:
a dispensing reel for supporting a label roll, the label roll having a plurality of labels attached to a backing strip;
a label releasing station for separating the label from the backing strip;
a take-up hub for receiving the backing strip thereon, the take up hub formed of a hub portion and a plurality of radially extending spokes extending from the hub portion to receive and support the backing strip after the labels have been removed from the backing strip; and
wherein the backing strip extends from the label roll and around the label releasing station such that an end of the backing strip is secured to the take-up hub between at least two radially extending spokes.

2. The take up hub of claim 1, further comprising a cantilevered portion extending from at least one of the radially extending spokes, wherein an end of the cantilevered portion and an adjacently positioned spoke form a gap to receive the end of the backing strip to secure the backing strip to the take up hub.

3. The take up hub of claim 2, wherein the cantilevered portion extends generally perpendicular to the at least one radially extending spoke.

4. The take up hub of claim 1, wherein the plurality of radially extending spokes extend equidistantly from the hub portion to form a backing strip support surface.

5. The take-up hub of claim 1, wherein the hub portion comprises an opening having a shape corresponding to the shape of a motor driven shaft to receive the motor driven shaft therein.

6. The label dispenser unit of claim 1, further comprising a movable guide rod positionable relative to the backing strip to apply a force on the backing strip.

7. The label dispenser unit of claim 1, wherein the label releasing station comprises a plate.

8. The label dispenser unit of claim 1, wherein the dispensing reel comprises a take-up hub.

9. The label dispenser unit of claim 1, further comprising a motor housing, wherein the motor housing comprises an L shaped bracket extending from a back wall of the motor housing for supporting the label dispenser.

10. A take-up hub for supporting an adhesive label backing strip, the take-up hub comprising:
a central hub portion;
a plurality of spokes extending outward from the central hub portion; and
a cantilevered portion extending from at least one of the spokes, the cantilevered portion extending toward an adjacently positioned spoke to form a gap to receive an end of the label backing strip to secure the backing strip to the take-up hub.

11. The take-up hub of claim 10, wherein the cantilevered portion extends generally perpendicularly from the at least one of the spokes.

12. The take-up hub of claim 10, wherein the plurality of spokes extend equidistantly to form a backing strip support surface.

13. The take-up hub of claim 10, wherein the central hub portion comprises an opening to receive a shaft driven by a motor.

14. The take-up hub of claim 10, wherein adjacently positioned spoke portions divergently extend from the central hub portion.

15. The take-up hub of claim 10, further comprising a chamber formed by the cantilevered portion extending from the at least one of the spokes toward the adjacently positioned spoke to receive the end of the label backing strip.

16. A label dispenser unit, comprising:
a dispensing reel for supporting a roll of labels attached to a backing strip;
a label releasing station for separating the label from the backing strip;
a take-up hub for receiving the backing strip thereon, the backing strip extending from the roll around the label releasing station and onto the take-up hub; and
a tensioner mechanism variably positionable relative to the backing strip to tension the backing strip as the backing strip wraps around the label releasing station.

17. The label dispenser unit of claim 16, further comprising a support frame, wherein the tensioner mechanism is positionable within a slot on the support frame to increase or decrease the tension of the backing strip.

18. The label dispenser unit of claim 16, wherein the tensioner mechanism comprises a rod extending from a support frame.

19. The take up hub of claim 16, further comprising a plurality of radially extending spokes extending from the hub portion, wherein the backing strip extends from the roll of labels around the label releasing station such that an end of the backing strip is secured to the take-up hub between at least two radially extending spokes.

20. The label dispenser unit of claim 16, further comprising a motor housing, wherein the motor housing comprises a mounting support for supporting the dispenser unit on a bin rack.

21. The label dispenser unit of claim 16, wherein the tensioner mechanism comprises a rod and a guide element movably disposed on the rod to accommodate backings strips of different widths, wherein the guide element is positioned between a locked position to prevent relative movement between the rod and guide element and an unlocked position, to facilitate movement of the guide element on the guide rod.
